(19) United States
(12) Patent Application Publication
(10) Pub. No.: US 2003/0177043 A1
(43) Pub. Date: Sep. 18, 2003

(54) Apparatus and method for digitizing, storing and retrieving radiographic images

(76) Inventor: Richard Gerlach, Rolling Hills Estates, CA (US)

Correspondence Address: ROBERT J. SCHAAP, Suite 188, 21241 Ventura Boulevard, Woodland Hills, CA, 91364, US

(21) Appl. No.: 10/341,804

(22) Filed: Jan. 13, 2003

Related U.S. Application Data
(60) Provisional application No. 60/351,080, filed on Jan. 22, 2002.

(51) Int. Cl. G06F 17/60

(52) U.S. Cl. 705/3

(57) ABSTRACT

Apparatus and method for the storage and transmission of radiographic images on a suitable film-like image bearing medium, and which includes a film advancing mechanism for moving a film past a reading station where light from fiber optic cables is used to create a reproduction in digital format of an image contained on the film. The recreated image in digital format is detected by a light bar, such that light passing through the image bearing medium impinges on photo-diodes which generate a digital representation of the image. This image can be stored and retrieved for long distance transmission and review at a remote site.

### RELATED APPLICATION

This application is based on and claims for priority the filing date of Provisional Patent Application Serial No. 60/351,080, filed on Jan. 14, 2002, for Apparatus and Method for Digitizing, Storing and Retrieving Radiographic Images.

### BACKGROUND OF THE INVENTION

1. Field of the Invention

An apparatus and a method for storing and transmitting data and, particularly radiographic data, from films and like substrates and which generally contains health care information and, more particularly, to a digitizing system which allows for rapid storage and retrieval and transmission of data or selected portions thereof.

2. Brief Description of Related Art

In recent years, the storage of medical records, re-accessing of those medical records and transmission of those records to a distant location for examination and consultation has become quite prominent. Very frequently, and with the increase in medical specialization, radiologists experienced in a certain facet of medical practice will possess a skill necessary for reading details of an image which are not immediately determinable by a general practitioner or other practitioner not experienced in that particular area.

In many occasions, a physician who is attending to a patient may not have the necessary degree of training or experience in determining the fine points of a radiographic image. This is frequently true where a physician may be, for example, on a cruise ship. Another example frequently arises in the case where a medical practitioner in a smaller city or town may not have the capability of examining an x-ray, an MRI printout, or the like. In all such cases the attending physician may have need for someone at a remote location to examine that radiographic image and provide information to the attending physician with respect to that image. Consequently, a careful and thorough analysis of information contained in that radiographic image may be required by a specialist.

In accordance with the present invention, an x-ray or magnetic resonance image (“MRI”), or a topographic image or other radiographic image bearing document, can be transmitted to a medical center having a staff capable of examining the document and providing the necessary information from such image.

The state of the art of apparatus for digitizing an image, storing the same, retrieving that image, and transmitting the image for display at a remote location has not kept pace with the increased demand for this type of service from the medical community. Although there are several apparatus which are available for accomplishing this end, these apparatus are typically lacking in one or more areas and the deficiencies in these apparatus often give rise to errors in the reading of the radiographic image. Consequently, there has been a need for an effective and highly accurate system for digitizing a radiographic image, storing same, retrieving the image and transmitting the image to a remote location for display.

Some of the numerous problems which exist in the prior art scanning and digitizing apparatus reside in mechanical mechanisms, such as those used for transport of the film, in the electrical circuitry, and even in the optical systems which are employed. With regard to the actual movement of the radiographic image past a scanning station, there are actually non-linearities in the movement of the film bearing the radiographic image, which materially interferes with an accurate reading of that film.

One of the problems which frequently exists in prior art digitizing scanning apparatus is the fact there is no accurate calibration of the light system which is required in these apparatus for permitting a scanning of the image and a generation of data from that image. Non-linearities in a light source will cause inconsistencies in the reading of an image. In these prior art apparatus, reading of a radiographic image occurs with successive scan lines being successively scanned and, hence, successively lighted. With an improper light source and, particularly, a non-linear light source, inaccuracy necessarily results.

There have been attempts to integrate the information resulting from the reading of a scan line in a radiographic image in order to compensate for light and dark areas in a light source. However, this integration did not properly account for light and dark areas, since a dark area located near an excessively lighted area was diffuse in the integration process causing some canceling out of the effect of the dark areas. In short, integration was not an effective technique for attempting to obtain a linear light source for scanning.

One of the optical-mechanical problems which exists in the prior art digitizing scanning apparatus is the fact that the drive mechanism does not drive the film at a linear speed throughout the scanning pass. Associated with this driving problem is the fact that thicknesses between films will vary. In addition, and a more particularly pronounced problem, is the fact that in a specific film, the thickness may vary across the length of that film. Consequently, the drive mechanism did not move the film, and hence the radiographic image, through the apparatus at constant speed. This speed variation necessarily introduced error into the image reading process. In other cases, films of differing thicknesses would be read differently.

There have also been attempts to provide mechanical drive systems and optical-mechanical reading mechanisms to obviate these problems. However, in the prior art, there has not been an effective drive mechanism or an effective optical-mechanical system for optically reading a film. One attempt at a drive mechanism which proved to be moderately effective for this purpose, was set forth in U.S. Pat. No. 5,093,734, dated Mar. 3, 1992, to Richard Gerlach. Although this apparatus overcame many of the disadvantages of prior art digitizing scanning apparatus, it was not an error free system.

In addition to the foregoing, there has not been an accurate calibration of the light system required for use in these apparatus to permit scanning of an image and generation of data from that image. Non-linearities in a light source will cause inconsistencies in the reading of an image. In these prior art apparatus, reading of a radiographic image occurs with successive scan lines being successively scanned and, hence, successively lighted. With an improper light source and, particularly, a non-linear light source, inaccuracy necessarily results.

There have been attempts to integrate the information resulting from the reading of a scan line in a radiographic image in order to compensate for light and dark areas in a light source. However, this integration did not actually properly account for light and dark areas, since a dark area located near an excessively lighted area was diffuse in the integration process causing some canceling out of the effect of the dark areas. In short, integration was not an effective technique for attempting to obtain a linear light source for scanning.

Various prior art apparatus attempted to account for non-linearities by calibration of these non-linearities in the light source. However, attempts to calibrate were inefficient, at best. Consequently, the light sources resulted in streaks in the image as the image changed from very light to very dark areas. In many cases, there were attempts to originally scan the document in a pre-scan operation, in order to measure non-linearities of a light source. This was followed by a second scanning movement in which data was read, in an attempt to overcome the non-linearity problem. However, this system was slow, costly, and not terribly effective.

In addition to problems in the light source, there were numerous problems in the archiving, locating and reproduction of a stored radiographic image. This is absolutely necessary for effective distribution of images to a proper source over a global communication link, such as the Internet, particularly to obtain high quality access to specialists and providing of an online archiving.

There is a need, and has been a need, for a low cost, accurate and highly effective system for digitizing a radiographic image and storing that image, and thereafter retrieving the image for distribution to one or more sources on a high speed basis, using a worldwide communication link. Thus, there has been a need for a system of this type which can be made available for low cost operation, and for very high speed transmittal of large quantities of stored radiographic images. Further, it is desirable to provide an apparatus which would allow for the reading of a radiographic image on a pixel by pixel basis, so that each pixel of an image could be accurately read and digitized to provide an accurate digital signal, and for retrieval of each of those signals to regenerate the image therefrom.

The prior art systems currently rely upon an arrangement of the type shown in the following described FIG. 1 and which is described in more detail hereafter. However, this prior art system still suffered from many of the disadvantages mentioned above, and also those hereafter described.

### OBJECTS OF THE INVENTION

It is, therefore, one of the primary objects of the present invention to provide an apparatus for reading a radiographic image, digitizing the image for storage of same, allowing for retrieval on an expedited basis, and which also allows for rapid transmission to a remote site.

It is another object of the present invention to provide a digitizing scanning apparatus of the type stated in which a radiographic image on a substrate can be read on a pixel by pixel basis and accurately digitized so that the entire image is accurately scanned for purposes of storage and retrieval and which allows for reproduction of an image almost as accurate as that which is stored.

It is a further object of the present invention to provide an apparatus for reading, storing and transmitting radiographic images of the type stated which allows for scanning of individual segments of radiographic image and digitizing those individual segments on a pixel by pixel basis, such that an electronic digital storage record accurately portrays the original radiographic image.

It is an additional object of the present invention to provide a fully integrated digitizing scanning-apparatus of the type stated which allows for accurate reading of a radiographic image with a light source while overcoming the disadvantage of non-linearities in the light source and which also allows for constant and precise movement of the radiographic image through the apparatus, such that there is a uniform reading and digitizing of an image on each occasion.

It is an additional object of the present invention to provide an apparatus of the type stated which can be made in a relatively small compact unit and which is highly efficient in operation and can also be produced at a relatively low unit cost.

It is another salient object of the present invention to provide a method of reading a radiographic image, creating a digital image format of that radiographic image, and allows for storage of same on a digital basis as a record, and allowing for retrieval of that record, transmission of the record and reproduction of same.

It is still a further object of the present invention to provide a method of the type stated which can be performed efficiently, accurately and which allows for transference of digital data at a high rate of speed.

With the above and other objects in view, my invention resides in the novel features of form, construction, arrangement and combination of parts and components presently described and pointed out in the claims.

### BRIEF SUMMARY OF THE INVENTION

The apparatus of the present invention is one which is designed to read a radiographic image and converting individual pixels of that image into digital format for ultimate storage. In this way, when each of the pixels of an image are read, an equivalent digital signal is generated and all of the digital signals constitute a digital signal format which, in combination, is representative of the radiographic image. This digital image pattern is then stored, such that it can be rapidly retrieved by conventional digital addressing. The retrieved image can then be transmitted via telecommunication link to a remote source where it may be reproduced and read at that remote source.

The aforesaid apparatus of this type is frequently referred to as a digitizing scanning apparatus inasmuch as the reading operation occurs through a series of successive scans of successive lines of the image. In this way, each pixel in each line of these successive scans is read and an equivalent digital signal therefor is stored.

The apparatus of the present invention is manufactured as a complete integrated unit, such that all of the individual components constitute a part of that integrated unit. The apparatus includes a unique drive mechanism which is the subject matter of a co-pending U.S. patent application. In substance, the drive mechanism is designed to drive a radiographic film through the apparatus uniformly regardless of variations in thickness of a film or variations between individual films.

More specifically, the drive system of the invention is designed to move a document being scanned through the scanning apparatus in such manner that it will always move at a uniform drive speed regardless of differences in thickness between successive documents or regardless of variations in the uniformity of thickness of any particular document. The drive system is constructed to automatically accommodate for these variations. Moreover, the drive system is constructed so that no chatter or vibration is imposed on the document being driven, such that uniform and accurate scanning is obtained.

The drive system of the invention includes two main drive rollers whose surfaces are connected at one end of the drive rollers by a smooth belt, such that the lower driver roller will also drive the uppermost roller at the exact same surface velocity, resulting in a smooth (i.e., “non-chattering”) film movement. A pair of floating idler rollers are also employed and are arranged to be in contact with or otherwise juxtaposed to the uppermost of the drive rollers and the lowermost of the drive rollers. No springs are employed in the mounting of the rollers and, hence, there is no variation in force provided by springs.

The idler rollers are actually mounted in a floating manner on pins so that the idler rollers can be shifted slightly away from the drive rollers in order to accommodate film thickness variations. The idler rollers are effectively floated for a limited degree so that each idler roller can be biased upwardly or downwardly and to a slight degree away from or toward the drive roller against which it is juxtaposed. This occurs automatically without the need for adjustment screws, such as set screws.

In this case, the drive system comprises a first drive roller and a second drive roller located in generally vertically spaced apart arrangement, whose surfaces are connected by a smooth belt at one end of the rollers away from the path of the driven film.

Positioned within the housing of the apparatus is a laser light source which is constructed so as to sequentially send a pure laser light through each of a plurality of successive fiber optic cables. The light from each of these successive fiber optic cables is then passed through the radiographic film as the film is passed through the apparatus. Located on the opposite side of each of the radiographic film with respect to the plurality of fiber optic cables is a light gathering system comprised of a plurality of individual charged coupled diodes with each charged coupled element associated with an individual fiber optic cable. Thus, the signals of each charged coupled diode is then electronically gathered and stored in the form of a digital image.

In each document to be scanned and digitized, such as a radiographic film, a plurality of successive scan lines extending across the document in one dimension, such as the width of the document, are established. Each scan line extends essentially transversely across this dimension, e.g., the width of the document, as aforesaid, and there are a plurality of scan lines successively arranged over the other dimension such as, for example, the length of the document. In each scan line there will be a plurality of scan operations, that is, where an individual scan or sampling is made. Consequently, a plurality of successive scan operations will take place transversely across the width of the document, such that there may be several hundred or over several thousand successive scan operations which take place in each scan line. Each scan operation essentially results in the detection of a pixel of light and the number of pixels of light is also independent of the number of optical fibers.

In accordance with the above-identified construction, it can be recognized that individual lines of the radiographic film are successively examined. Each pixel of each line is also individually examined with a separate fiber optic cable. The fiber optic cable arrangement is constructed so that digital signals are generated in response to light passing through a selected element of the film. In this way, each pixel of each successive line of a film is examined and a digital signal is stored for each pixel. By virtue of this construction, the inaccuracies resulting from non-linear light sources, the variability in the light and the light sources and non-linearities of film movement are obviated. This is due to the fact that each selected segment of an image is examined on a line by line basis and on a pixel by pixel basis in each successive line. Due to this fact, the resultant image when accessed and reproduced is a highly accurate reproduction of the original image.

Due to the fact that each image is successively scanned on a line by line basis and on a pixel by pixel basis, much of the attendant apparatus used in prior art digitizing scanning apparatus to provide compensation and the like has been eliminated. As an example, there is no need to insure for variable drive motors to maintain constant film speed movement, there is a lack of need for complex drive and idler arrangements to compensate for variations in film thickness, and the like. The apparatus thus provided is relatively simple in its construction, but highly accurate in its operation. Moreover, in view of the fact that complex mechanical mechanisms can be avoided, the apparatus can be constructed more simply and operation can be electronically accomplished.

The present invention also provides a method of reading a radiographic image on a line by line basis and on a pixel by pixel basis with each line successively examined and each pixel in that line successively examined. As the pixels are examined, in accordance with the method of the invention, an electrical signal is generated and that signal is stored. The resulting composite digital signal is an accurate portrayal of the original image which is digitized. This electronic facsimile of the image can be easily electronically addressed and transmitted via telecommunication links to a remote source where an accurate reproduction of the original image can be obtained.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings (eight sheets) in which:

FIG. 1 is a schematic view of a prior art laser scanning system, customarily used in the vast majority of prior art scanning systems for storing and retrieving radiographic images;

FIG. 2 is a perspective view of a radiographic image digitizing scanning apparatus, constructed in accordance with and embodying the present invention;

FIG. 3 is an end elevational view of the radiographic image digitizing apparatus of FIG. 2, with a side wall thereof effectively removed, and showing the interior thereof, and also with the back plate which allows access, in a closed position;

FIG. 4 is an end elevational view of the radiographic image digitizing apparatus of the invention, and showing the interior of the apparatus, in a manner similar to FIG. 3, except with the back plate thereof in the opened position to allow access therein;

FIG. 5 is a rear elevational view showing portions of a drive mechanism and a light linearizing bar, taken substantially along the plane of line 5-5 of FIG. 4;

FIG. 6 is a fragmentary plan view showing the interior face of the back plate forming part of the apparatus of the invention, when opened, and taken substantially along the plane of line 6-6 of FIG. 5;

FIG. 7 is a front elevational view showing the interior of the digitizing scanning apparatus, and particularly, the light distribution mechanism thereof with many of the other components removed for purposes of clarity;

FIG. 8 is an end elevational view showing, in particular, the light distribution mechanism of the present invention; and

FIG. 9 is a somewhat schematic elevational view showing the relationship between the light distribution mechanism and the light receiving and detecting mechanism, and its relationship to a radiographic film.

### DETAILED DESCRIPTION OF A PREFERRED EMBODIMENT

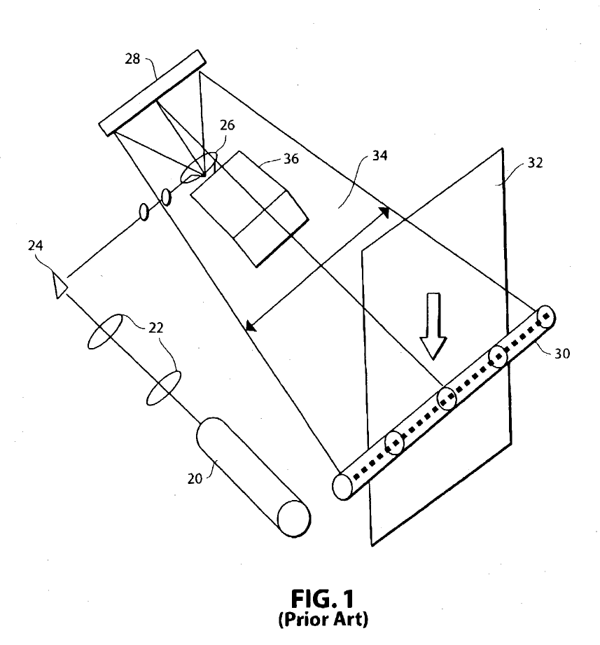

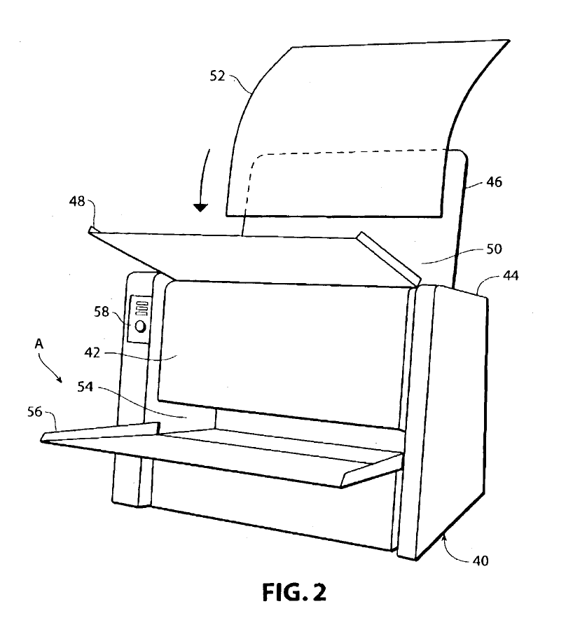

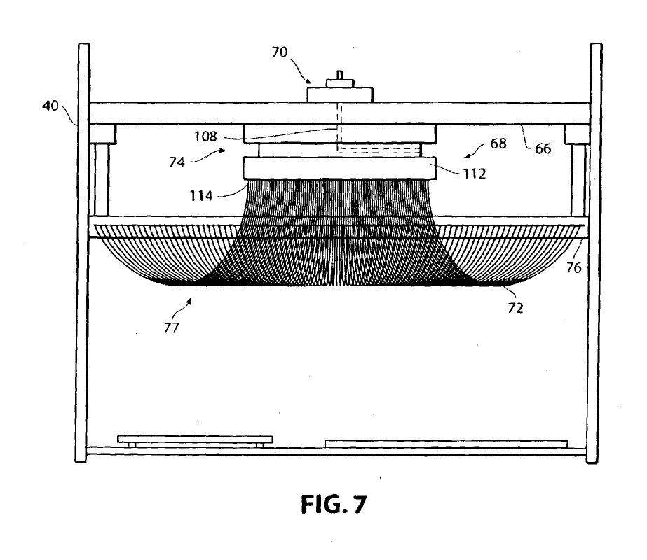

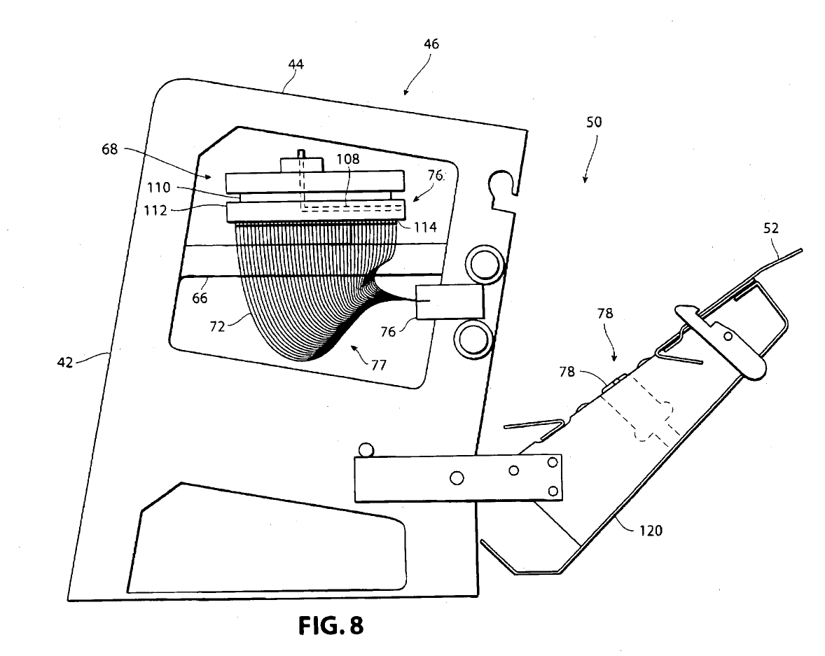

Referring now in more detail and by reference characters to the drawings, reference will initially be made to FIG. 1, which shows a typical prior art laser scanning system for scanning radiographic images. FIGS. 2-9 of the application more particularly relate to the apparatus and the method of the present invention.

Referring in more detail to FIG. 1, it can be observed that the prior art laser scanning systems generally rely upon a gas laser 20, including a plurality of condensing lenses 22, and a prism 24 directing light to a conical prism 26, and a folding mirror 28. That light from the mirror 28 is then directed to a photomultiplier detector 30. However, the light passes through the radiographic film substrate 32 and will thereupon provide a reading of the light and dark areas to the photomultiplier detector 30. The scanning beam generated at the folding mirror 28 is represented by the path 34. Moreover, a galvanometer 36 must be used in this arrangement to control raster scanning of the laser beam.

In substance, it can be observed that the prior art laser scanning systems, while being different from, nevertheless rely upon, technology similar to that used in conventional photocopiers. However, the prior art digitizing scanning systems, nevertheless, suffer from a large number of significant disadvantages, not the least of which is the high cost of expensive components coupled with high manufacturing costs.

Some of these expensive components, mentioned above, include the gas laser which is used since it degrades over time, requiring periodic calibration and eventual replacement. Usually, replacement is required every 2,000 to 5,000 hours, and usually by a qualified manufacturer/trained technician. The photomultiplier detector is also a costly item which similarly degrades over time, and also requires system re-calibration and eventual replacement. A galvanometer is costly and must be an accurate galvanometer to control raster scanning of the laser beam. This galvanometer also requires periodic calibration and very delicate adjustments. There is also a complex array of precision lenses and mirrors. Moreover, with these lenses and mirrors, every surface of same contribute to the veiling glare, as a result of edge reflections and surface contamination. The surface contamination is impossible to eliminate, and is typically caused by dust in the air. However, these mirrors and lenses require periodic cleaning and adjustment by trained technicians, or otherwise, pixel measurements are compromised.

Those disadvantages mentioned above are only some of the major disadvantages. However, it is noteworthy that there is down time due to the need for periodic cleaning and adjustment. In addition, a premature burn-out of, for example, the gas laser or photomultiplier could require early replacement. Although some manufacturers may provide a warranty policy, even that policy is expensive and adds to the overall cost of the system.

As indicated above, FIGS. 2-9 of the drawings more particularly illustrate both the apparatus and the method of the present invention. Returning now to FIGS. 2-9, A represents a radiographic image storage and retrieval apparatus, which includes an outer housing 40 having a front wall 42 and a top wall 44. A pair of plates 46 and 48 define a space for a feed slot 50 to receive a radiographic film substrate 52. The front wall 42 is also provided with an elongate exit slot 54 and a film receiving tray 56, to receive the film 52 after the same has been read and is discharged through the slot 54.

The apparatus is also provided on the outer housing 40 with a control panel 58, containing those controls necessary for the operation of the apparatus. These controls typically include an off-on switch, a speed control, and the like.

A horizontal support plate 66 mounted within the apparatus supports the laser light distribution system 68, which is one of the key components forming part of the apparatus of the present invention. This laser light distribution system includes a laser light source 70, a plurality of fiber optic cables 72, and a laser light feed mechanism 74. The laser light distribution system also includes a light linearizing distribution bar 76.

In brief summary, optical fibers are connected to a stationary plate 79, forming part of the light feed mechanism 74, and receives light from a light feed filament, hereinafter described, for distribution to each of the individual optical fibers 72. The light feed filament rotates around the ends of each of the individual fibers 72. These fibers 72 have first ends mounted on the plate 79 and second ends located at the rear side of the light distribution and linearizing bar 76. In this way, light from a rotating distribution feed is introduced into a linearizing distribution member for ultimate use. In particular, the light is passed through the film substrate 52 and detected by a detector mechanism 78, along with a light processing mechanism. As the film substrate 52 is moved past the light distribution bar and the light detecting mechanism 78, the light passing through the substrate 52 is detected and read for ultimate conversion to electrical signals for storage and retrieval.

This light distribution system is more fully described in my U.S. patent application Ser. No. ______, filed Jan. 13, 2002, based on my U.S. Provisional Application Serial No. 60/351,209, filed Jan. 14, 2002, and entitled “Light Distribution System for Scanning a Radiographic Image.” The light detecting and processing mechanism is also described in my copending U.S. Utility Patent Application Serial No. ______, also filed Jan. 13, 2003, and based on my U.S. Provisional Patent Application Serial No. 60/351,209, filed Jan. 14, 2002, and entitled “Light Receiving and Detection System for Reading a Radiographic Image.”

Also mounted within the housing of the apparatus are one or more electronic circuit boards 82, which control the actual operation of the apparatus. In addition, the apparatus could include its own internal power supply (not shown). Inasmuch as the actual electronics is only that necessary for operating the drive system and, essentially, the optical system herein, it is neither illustrated nor described in any further detail herein. However, it is important to note that an encoder 84 also forms part of the apparatus, so that the light levels may be read on an encoded time basis.

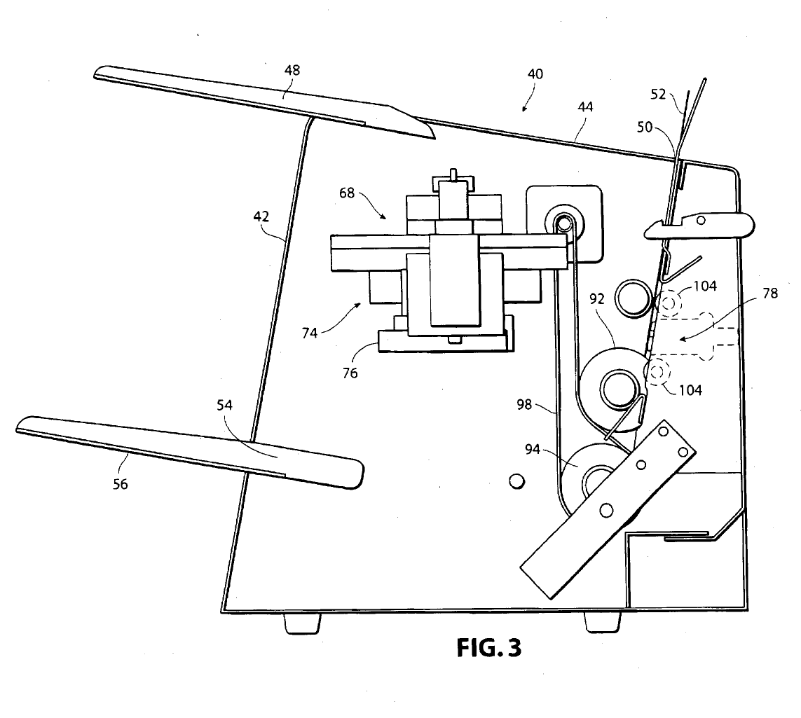

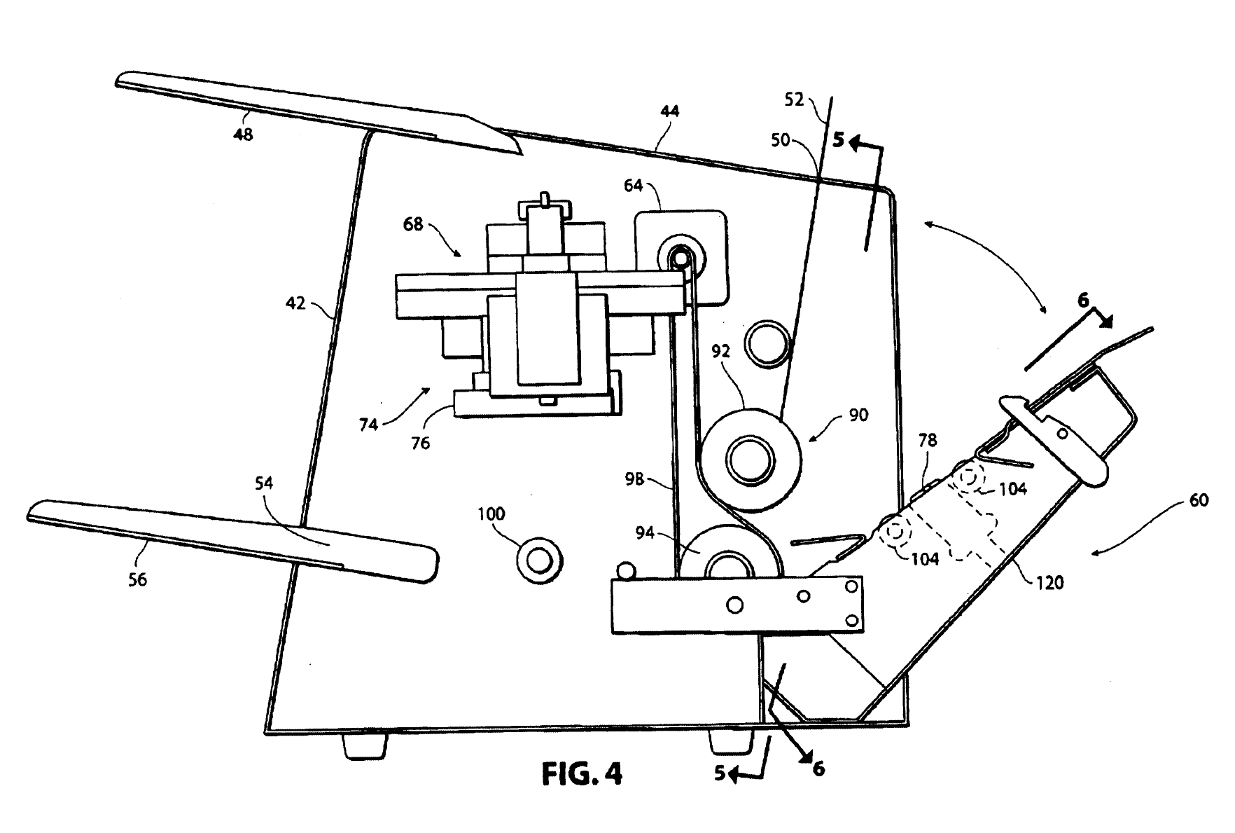

FIGS. 3 and 4 of the drawings more fully illustrate the arrangement of some of these previously described major components forming part of the radiographic image digitizing apparatus of the present invention. As indicated previously, a substrate carrying a radiographic image, such as the substrate 52, is introduced into the input slot 50. A drive mechanism 90 located on opposite sides of the input slot 50, and includes a main drive roller, which is powered by an electric drive motor 94. A secondary drive roller 96 is driven by a drive belt 98 which is trained about the motor 64, as well as the main driver roller 92 and 96. In addition, an idler roller 100 on one side of the intake slot 50, as well as a pair of idler rollers 102 on an opposite side of the intake slot, also engage the substrate, such as the substrate 52, as it passes through the input slot 50. The details of the drive mechanism, and the benefits of this drive mechanism, are more fully illustrated and described in my co-pending U.S. patent application Ser. No. 09/594,704, filed Jun. 12, 2002, and which is entitled “Drive System for Digitizing Scanning Apparatus.”

The drive mechanism of the present invention obviated many of the problems associated with the prior art drive apparatus, and overcomes the non-linearity in film thickness which causes the drive mechanism to move the film through the apparatus at uneven speeds. As can be appreciated, this necessarily introduced error into the image reading process. In other words, the document being scanned will always move at a uniform drive speed and, hence, a uniform scan speed, regardless of the differences in thickness between various successive documents, or regardless of the variations in the uniformity of thickness of any particular document. In addition, the drive mechanism is constructed so that no chatter or vibration is imposed on the document being driven.

The advantages of this drive system and the problems which were overcome are more fully described in that aforesaid co-pending U.S. patent application on this drive mechanism.

Also located in the housing of the apparatus is a laser light distribution mechanism 74, having a suitable laser light source 76. The laser light source 76 operates with an actual fiber optic light carrying distribution arrangement 77, having a light distribution bar, as hereafter described, often referred to as a light linearizing bar, since it takes light from a circular array of optical fibers and essentially places the outputs in a linear array, as hereafter described.

A single fiber optic lead or feed optic 108 is located through a disc 110, causing light to be delivered to another disc 112, receiving first ends 114 of the plurality of optical fibers 72. Thus, laser light is received from the light source 70 into the optical fiber feed 108, and then the light is successively delivered to each of the optical fibers 72. It can be observed that first ends 114 of these optical fibers are arranged around the disc 112, and located to receive the light from the optical feed fiber 108. Thus, the optical fibers 72 will each carry light successively distributed by the optic feed fiber 108. That light carried by each of the optical fibers is then delivered to the light linearizing bar 76.

The encoder 84 also forms part of the light distribution mechanism, and is designed to provide a clock time basis when light from the linearizing bar 76 is directed through the radiographic image during a scanning operation, and in effect, provides an identification of each pixel of light measured in each of the individual scan operations in each successive scanned line on the document.

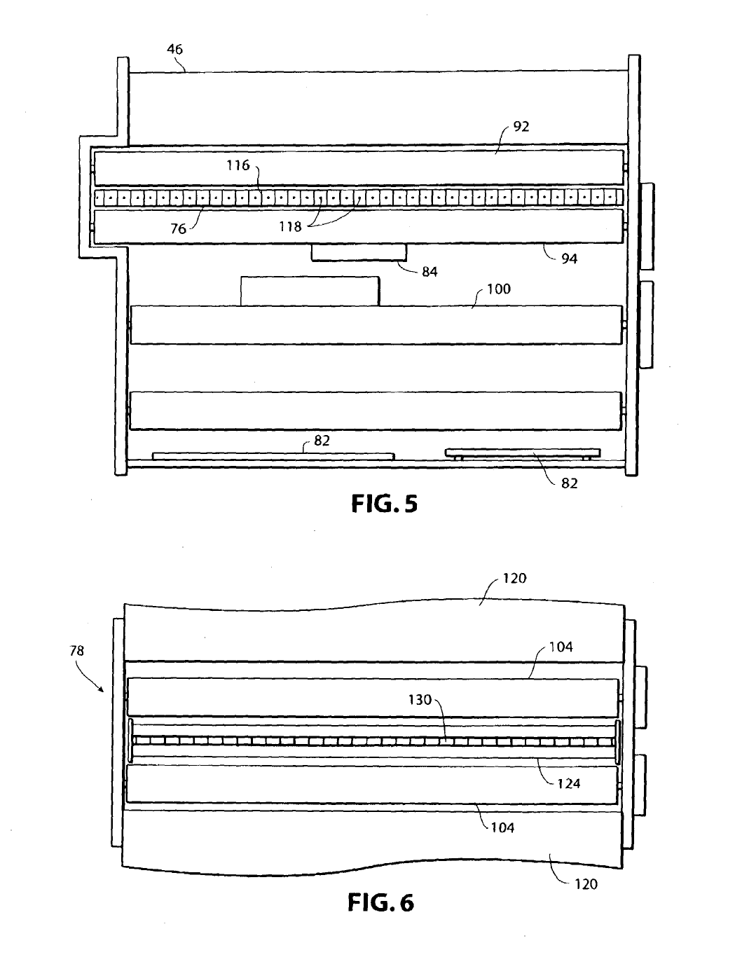

The light linearizing bar 76 is also more fully shown in FIG. 5 of the drawings. The bar is subdivided into a plurality of compartments 116, with each compartment receiving an opposite or second end 118 of each of the optical fibers 72. Thus, in the preferred embodiment of the invention, in which there are 3,600 optical fibers, allowing for up to 3,600 scan points, there will be 3,600 pixels in each scan line of the document being scanned, and hence, there are 3,600 individual compartments 116 in the light linearizing bar.

The housing 40 of the apparatus has an openable back section 120, which is hinged along the lower end of the housing 40, and provides access to the interior of the housing for cleaning, adjustment and/or repair. The openable back 120 also effectively defines the film input slot 50.

By reference to FIGS. 2, 3 and 8, it can be seen that the film 52 will be driven by the drive mechanism 90 and through the scanning path, partially defined by the feed path, in the digitizing scanning apparatus. Located on the opposite side of the scanning path, and hence, the film 52 passing therethrough, with respect to the light linearizing bar 76, is a light detector mechanism 102. The light detector mechanism 78 includes a light detecting and integrating bar 104, as best shown in FIG. 6. It is also subdivided into a plurality of compartments 108, and each having a light detector, such as a photo-diode, for detecting the light impinging thereon. Typically, the number of compartments 108 will be equal to the number of compartments 94.

The light detectors are essentially photo-diodes and, again, there may preferably be a number of photo-diodes equal to the number of optical fibers. In this way, when light is detected on a scan time basis, with each scan time being determined by the encoder 92, each photo-diode in succession will be energized.

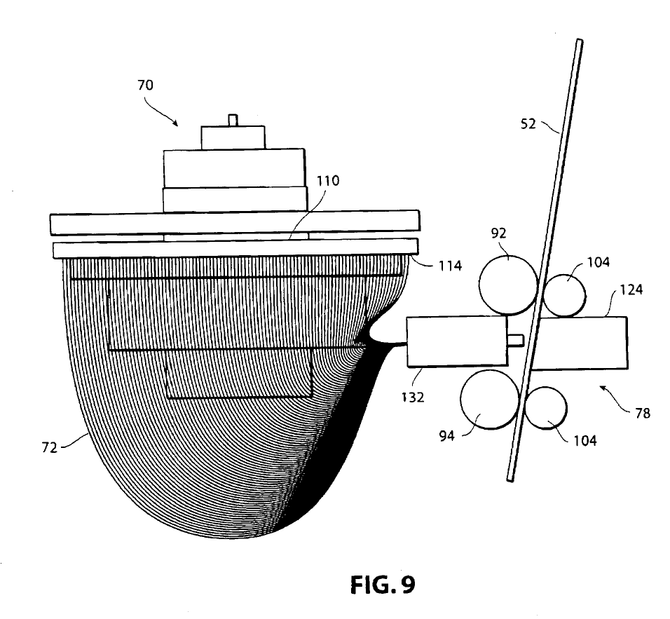

The light detector mechanism is more fully illustrated in FIGS. 6 and 9 of the drawings, and comprises photo-diodes 130, which each receive the light and along with an amplifier (not shown), to amplify the signals representative of the detected light. A Selfoc lens 132, as best shown in FIG. 9 of the drawings, could also be used and is located on the opposite side of the substrate 52. In accordance with this construction, it can be observed that the light values read from the film 52 are then locationally identified and effectively reproduced in the same arrangement in the printing process. The actual operation of the mechanism for reading the amount of light is more fully illustrated and described in that co-pending U.S. patent application Ser. No. ______, filed Jan. 13, 2002, and entitled “Light Receiving and Detection System for Reading a Radiographic Image.”

Although not shown specifically, the apparatus also includes a storage mechanism for storing all of the data which is read from the radiographic image for ultimate retrieval and transmission. Thus, the device can be, and is, manufactured as a low cost, completely integrated unit.

The apparatus of the invention presents many advantages which are not available in any of the prior art systems. For example, the apparatus of the invention provides a perfect geometry of plus or minus one pixel in any scan. Moreover, this is true even with fourteen inch by seventeen inch films. Secondly, the invention provides a sealed optical system. In effect, there is a clean exit surface on the entrance, and a clean exit surface on the light guide. Thirdly, there is no periodic adjustment required. More importantly, the device is very inexpensive. In fact, it can be constructed so inexpensively, and with such almost failsafe components, that if there is a failure, it is possible to merely swap one device for another.

The device of the invention is also highly toolable. This enables mass production. In addition, there is no optical bench, such as the lenses and mirrors which are used in all prior art systems. In these prior art systems, the geometry continuously failed, whereas in the present system, the print is almost perfect on each occasion.

One of the very important advantages is the fact that there is no veiling glare. In effect, there is no sharp black to white contrast, due to the fact that several hundred pixels are not affected by the glare. The system of the invention is highly accurate, stable, durable and reliable. It provides perfect rotation in an X-Y axis, along with high stability and constant velocity. It has a highly accurate, high density clock track, providing for high resolution sampling. In effect, the disc speed, film feed and pixel sampling are interlocked with plus or minus one pixel geometry over the entire film. Inasmuch as the output is always focused, there are no Newton interference patterns. The sealed optical path eliminates the need for cleaning and adjustment. Further, there is no cosine-4 power roll-off.

The film is moved through the apparatus with a clamshell design. As a result, there is perfect and constant surface velocity. There is also a constant drive load independent of the film thickness. The laser output sensor is solid state and very rugged. It is also linear over seven decades. The entire system thereby provides superior image quality, better reliability, fewer service calls, and a system which is highly manufacturable at a low cost.

Thus, there has been illustrated and described a unique and novel apparatus and method for digitizing, storing and retrieving radiographic images, and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what we desire to claim and secure by letters patent is:

1 An apparatus for the storage and transmission of radiographic images contained on a radiographic image substrate, said apparatus comprising:
a) a housing;
b) a drive mechanism located within said housing and capable of driving said substrate without chatter;
c) a light source;
d) individual optical fibers delivering light from said light source to a scan line on the radiographic image substrate and with the drive mechanism moving the substrate to provide a series of successive scan lines with each scan line containing a plurality of pixels representing a portion of the image on the substrate; and
e) a detector station for detecting successive light pixels in each scan line and on each of the successive scan lines of the radiographic image for generating electrical signals representative of the image and allowing for electronically storing same.

2 The apparatus for the storage and transmission of radiographic images of claim 1 further characterized in that said apparatus comprises an elongate light collecting bar which collects light from each of the optical fibers so that each scan line of the radiographic image on the substrate is successively lighted and scanned.

3 The apparatus for the storage and transmission of radiographic images of claim 2 further characterized in that a light distribution system collects the individual pixels of light and concentrates all of said pixels before detecting same with said detector station.

4 The apparatus for the storage and transmission of radiographic images of claim 1 further characterized in that a linearly extending light linearizing and collecting bar is located in a position to receive light from ends of each of the optical fibers and causes that light to pass through the substrate carrying the radiographic image to a light detecting member at said detector station.

5 The apparatus for the storage and transmission of radiographic images of claim 4 further characterized in that the detector station receives the light signals from the light distribution member in an analog format and thereafter allows for conversion to a digital format where the data represented by the signals can be electronically stored for ultimate retrieval.

6 The apparatus for the storage and transmission of radiographic images of claim 1 further characterized in that said light source is a laser light source.

7 The apparatus for the storage and transmission of radiographic images of claim 1 further characterized in that said drive system uses a plurality of drive rollers located on one side of said substrate to engage said substrate, and a plurality of idler rollers on the opposite side of the substrate and which also engage the substrate.

8 An apparatus for the storage and transmission of radiographic images contained on a radiographic image substrate, said apparatus comprising:
a) a drive system located with respect to a substrate for causing movement of the substrate;
b) an image lighting station located with respect to the moving substrate and which image lighting station includes a plurality of separate optical fibers with each separate fiber being arranged to light successive portions of each scan line on the image bearing substrate;
c) a light collection station located on an opposite side of the radiographic image substrate with respect to the image generating station and receiving pixels of light passing through the substrate for each of the successive scan lines on the substrate; and
d) means associated with said light collection station for converting the pixel of light and generating equivalent electrical signals therefrom.

9 The apparatus for storage and transmission of radiographic images of claim 8 further characterized in that each light collection station comprises a light concentrating member forming part thereof and integrating each of the pixels of light in each successive scan line into a form suitable for detecting the amount of light and converting to said electrical signals.

10 The apparatus for the storage and transmission of radiographic images of claim 8 further characterized in that said apparatus comprises a housing containing the drive system and the image lighting station and the light collection station, and an input means for receiving the substrate and an output means for returning the substrate.

11 The apparatus for the storage and transmission of radiographic images of claim 8 further characterized in that the electrical signal generating means generates said signals in analog format and means is associated therewith to convert the analog signal format to a digital signal format for recordation and retrieval of the information representative of each of the images.

12 An apparatus for the storage and transmission of radiographic images of claim 8 further characterized in that said apparatus comprises:
a) a light source at said image lighting station;
b) first ends on said optical fibers located at said light source; and
c) second ends on said optical fibers located at said light collection station.

13 The apparatus for the storage and transmission of radiographic images of claim 12 further characterized in that said first ends are located at said light source in a generally circular array and said second ends of said optical fibers are located in a linear array at said light collection station.

14 The apparatus for the storage and transmission of radiographic images of claim 12 further characterized in that said light collection station comprises a light detector means for generating the electrical signals, and which signals are in analog format and said apparatus comprises means for converting those signals to digital format.

15 An apparatus for the storage and transmission of radiographic images contained on a radiographic image substrate, said apparatus comprising:
a) an input for receiving a substrate bearing a radiographic image and initially moving same in a path through said apparatus;
b) drive means located at said path for moving said substrate therein;
c) laser light means for generating light along individual optical fibers having first ends gathering light at said laser light means;
d) second ends of each of said optical fibers terminating at said path and carrying laser light for lighting the image;
e) light collection means collecting the light on an opposite side of said path with respect to said second ends of said optical fibers and thereby generating a light pattern capable of being converted to electrical signals to represent the image scanned on said substrate; and
f) exit means for returning the substrate after scanning thereon.

16 The apparatus for the storage and transmission of radiographic images contained on a radiographic image substrate of claim 15 further characterized in that said first ends of said optical fibers are located in a circular array with respect to said laser light means and said second ends of said optical fibers are located in a linear array to linearize the light means received at said light collection means.

17 The apparatus for the storage and transmission of radiographic images contained on a radiographic image substrate of claim 16 further characterized in that said apparatus comprises means for delivering the light at said laser light means to the first ends of each of the optical fibers successively in that circular array and where the light exits the linear array at the second ends.

18 A method of scanning a radiographic image contained on a radiographic image substrate in order to generate electrical signals representative of that radiographic image, said method comprising:
a) moving a radiographic image substrate through a housing;
b) generating light in said housing from a light source;
c) locating optical fibers at said light source to deliver light successively through each of the optical fibers to said radiographic image; and
d) locating the light detector means on the opposite side of said radiographic image to detect the light passing through said substrate.
